(19) United States
(12) Patent Application Publication
(10) Pub. No.: US 2010/0139187 A1
(43) Pub. Date: Jun. 10, 2010

(54) Steel Door and Jamb Fabrication

(75) Inventors: Michael Medina, Austin, TX (US); Marti Medina, Austin, TX (US)

Correspondence Address: VENABLE, CAMPILLO, LOGAN & MEANEY, P.C., 1938 E. OSBORN RD, PHOENIX, AZ, 85016-7234, US

(73) Assignee: PORTELLA ENTERPRISES, INC., Austin, TX (US)

(21) Appl. No.: 12/329,792

(22) Filed: Dec. 8, 2008

(51) Int. Cl. E06B 1/14

(52) U.S. Cl. 52/204.1; 52/656.4

(57) ABSTRACT

A steel door system is disclosed. The steel door system includes a steel door, a steel door jamb, and a steel window frame. Each component of the steel door system is made with minimal materials and joints. The minimal materials and joints greatly reduce the risk of failure of the final steel door system. The steel door is made of steel door stiles and rails that are each formed of a single piece of sheet metal. The steel door jamb is made of three pieces of sheet metal, and the steel window frame is made of three pieces of sheet metal. These components are coupled together to create the finalized steel door system.

### FIELD OF THE INVENTION

The present invention relates generally to door and door jamb fabrication, and more particularly, to a steel door and steel door jamb that are each constructed of components made of a single piece of sheet metal.

### BACKGROUND OF THE INVENTION

The invention is a method for manufacturing steel doors and steel door jambs. The current method has eliminated the need for materials and labor required by the conventional process of manufacturing. Specifically, the method is unique in that it integrates door stops and glass stops into a single formed component of the door or door jamb assembly. Typically, a steel door and steel door jamb are assembled using numerous pieces of metal that have been screwed, welded, glued, and/or nailed together. The end result of this prior art process requires intensive grinding, use of fillers to hide joint assembly, sanding, and polishing. In addition, the more joints involved in a structure weaken the structure and make it more susceptible to failure. In contrast, the current improved invention eliminates or reduces the above steps and joints involved in the structure.

Further, the speed at which a completed unit can be manufactured according to the current invention reduces overhead and costs. Additionally, the variety of materials needed is reduced. The product integrity increases with the reduction of components necessary to produce the product. The end product doors and door jambs have less weakness and chance of failure due to welds and joints. Because joints are generally the weakest part of a door or door jamb, that is where the door or door jamb will fail. With the invention disclosed herein, however, the number of joints are eliminated or reduced and therefore, there is less likelihood of failure of the final product.

### SUMMARY OF THE INVENTION

In the current invention, the steel door and steel door jamb are formed utilizing a brake press fitted with interchangeable specialized dies that form one piece steel components. These components are coupled together with minimal joints and fastening to create the steel door and jamb system of the current invention.

In the preferred embodiment, the steel door comprises steel stiles and rails that are constructed of 14 gauge sheet metal formed by a brake press machine to a current industry standard of 5½″ wide to a minimum 1¾″ thick up to 2¼.″ Moreover, the door jamb is constructed of 14 gauge sheet metal formed by a brake press machine to a current industry standard of 4 3/16″ wide to 2⅜″ thick. The steel door and jamb are each constructed of single specialized components that are formed from a single sheet of metal. First, the sheet metal is cut to the desired and/or required length. Then, using the interchangeable dies, the steel is formed into rectangle shapes. The steel door stiles and steel door rails are then cut to the required lengths. The 45° end cut portions of the steel door stiles and steel door rails are welded together to form a steel door. The steel door jamb is formed in a similar way only the bottom horizontal piece is not needed. Once the steel door and door jamb are assembled, the unit functions as a conventional door.

A steel door system as in the present invention comprises a steel door jamb and a steel door. The steel door jamb further comprises a top piece wherein the top piece further comprises a first side and a second side and a pair of side pieces wherein each side piece further comprises a first edge and a second edge. The steel door further comprises a pair of steel door stiles wherein the pair of steel door stiles each has a first side and a second side, and a pair of steel door rails wherein the pair of steel door rails each has a first edge and a second edge. The top piece and the pair of side pieces of the steel door jamb are each comprised of a single sheet of steel. Moreover, the pair of steel door stiles and the pair of steel door rails each comprise a single sheet of steel. The steel door jamb is created by coupling the first side of the top piece of the steel door to the first edge of one of the side pieces of the steel door jamb and coupling the second side of the top piece of the steel door jamb to the first edge of the second side piece of the steel door jamb. The steel door is created by coupling the first side of one of the steel door stiles to the first edge of one of the steel door rails and coupling the second side of the steel door stile to the first edge of the second steel door rail. Next the first side of the second steel door stile is coupled to the second edge of the first steel door rail and the second side of the second steel door stile is coupled to the second edge of the second steel door rail. Finally one of the steel door stiles is rotatably coupled on an axis to one of the side pieces of the steel door jamb such that the steel door system is created.

The present invention is directed to a steel door system that comprises minimal components and joints.

It is a further object of the present invention to provide a steel door system that is cost effective to manufacture.

It is a further object of the present invention to provide a steel door system that is less likely to suffer from failure due to weak joints.

It is a further object of the present invention to reduce the materials used to produce a steel door system.

The novel features that are considered characteristic of the invention are set forth with particularity in the appended claims and drawings. The invention itself, however, both as to its structure and its operation together with the additional object and advantages thereof will best be understood from the following description of the preferred embodiment of the steel door and jamb fabrication. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6 are sought to be invoked to define the invention(s), the claims will specifically state the phrases “means for” or “step for” and a function, without also reciting in such phrases any structure, material, or act in support of the function.

Moreover, even if the provisions of 35 U.S.C. §112, paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later developed equivalent structures, materials, or acts for performing the claimed function.

### BRIEF DESCRIPTION OF THE DRAWINGS

FIG. 1A shows the prior art steel door stile.

FIG. 1B shows the prior art steel door jamb.

FIG. 1C shows the prior art steel window frame.

FIG. 2 shows a side view of a steel door stile of the present invention.

FIG. 3 shows a side view of a steel door jamb component of the present invention.

FIG. 4 shows a side view of a steel window frame component of the present invention.

FIG. 5 shows a side view of a component of a steel window frame of the present invention.

FIG. 5A shows a side view of a component of the steel window frame of the present invention.

FIG. 5B shows a side view of the steel window frame components coupled together.

FIG. 6 shows a side view of the steel door jamb component of the present invention.

FIG. 7 shows a side view of the steel door stile of the present invention.

FIG. 8 shows a top cross section view of a steel door system that includes the steel door jamb, steel door, and steel window frame of the present invention.

FIG. 9 shows a close cross section view of the components shown in FIG. 8.

FIG. 9A shows a close cross section view of the components shown in FIG. 8.

FIG. 9B shows a close cross section view of the components shown in FIG. 8.

FIG. 10 shows an exploded view of the steel door, steel door jamb, and steel window frame assemblies of the present invention.

FIG. 11 shows a detailed view of the steel window frame coupled to the steel door stile on a latch side.

FIG. 12 shows a detailed view of the latch of the window frame.

FIG. 13 shows a detailed view of the hinges of the window frame.

FIG. 14 shows a detailed view of the steel window frame coupled to the steel door stile on a hinge side.

### DESCRIPTION OF PREFERRED EMBODIMENT

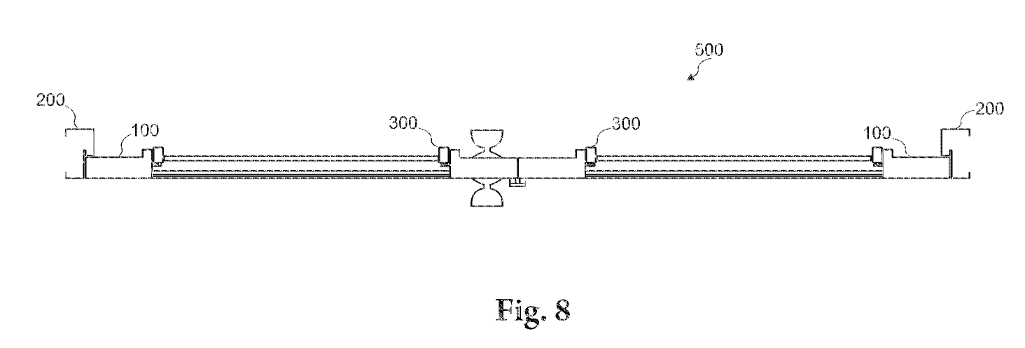

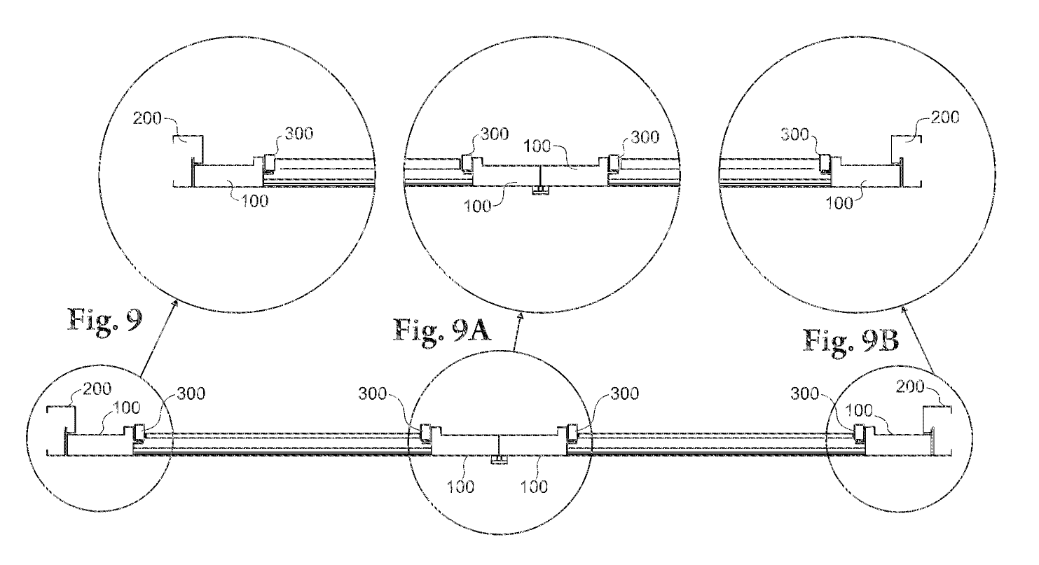

The preferred embodiment of the present invention includes a steel door 100, a steel door jamb 200, and a steel window frame 300 that are each constructed of components made of a single piece of steel. The steel door 100, steel door jamb 200, and steel window frame 300 are coupled together to create a steel door system 500 as shown in FIG. 8.

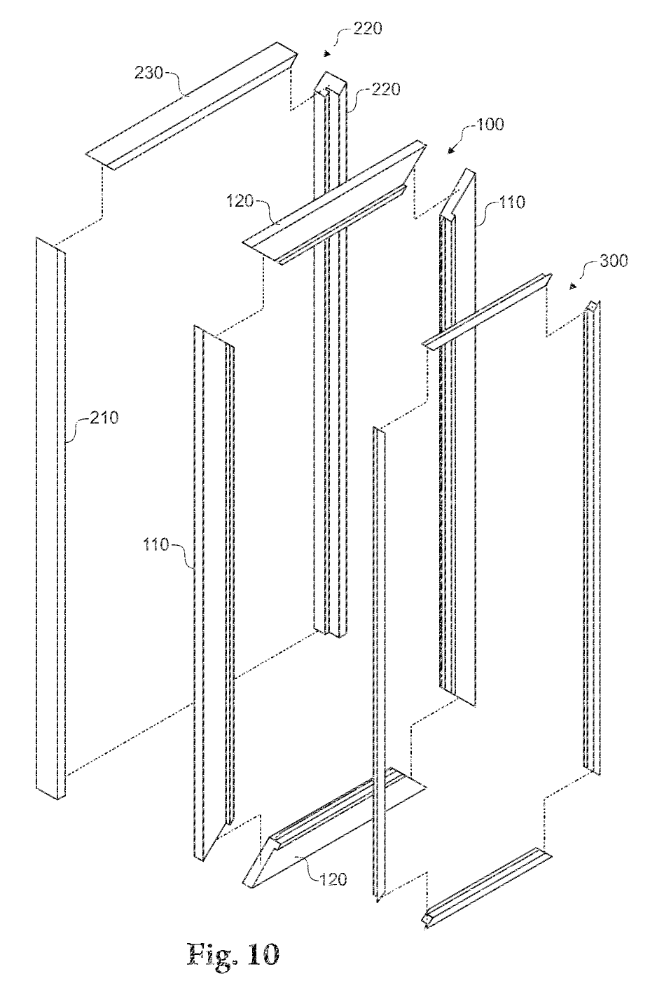

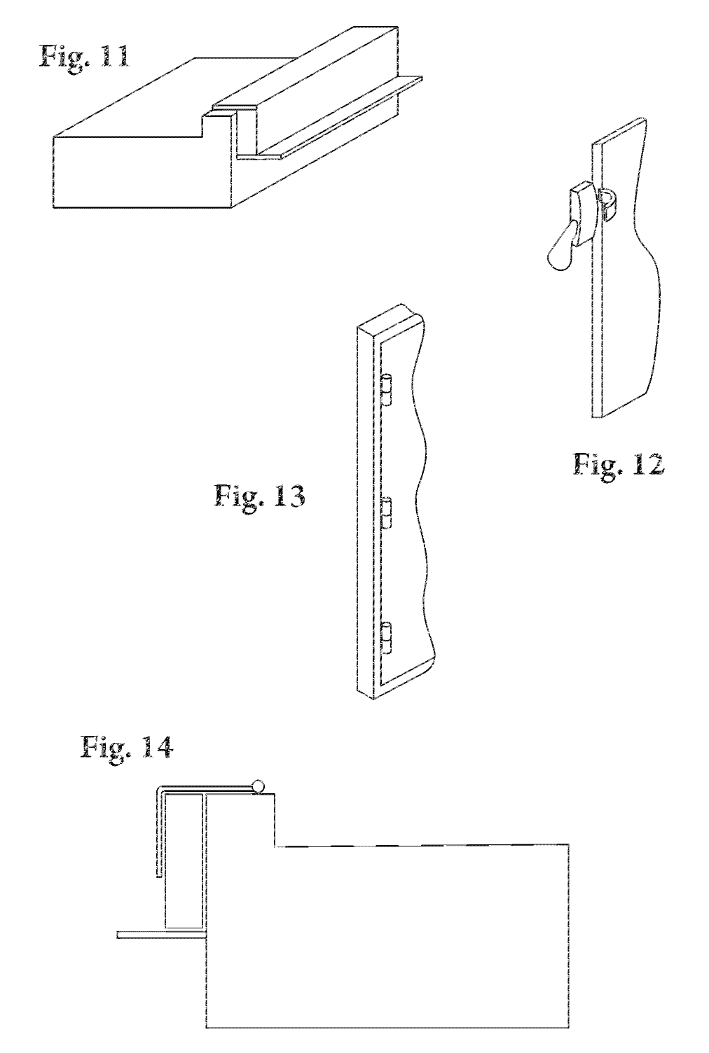

In the preferred embodiment, sheet metal is formed into rectangular shapes to create the components of the steel door 100, the steel door jamb 200, and the steel window frame 300. The steel door 100 is comprised of steel door stiles 110 and steel door rails 120. The steel door stiles 110 and steel door rails 120 are welded together at their respective ends to create the steel door 100. The steel door stiles 110 are arranged vertically, and the steel door rails 120 are arranged horizontally as seen in FIG. 10.

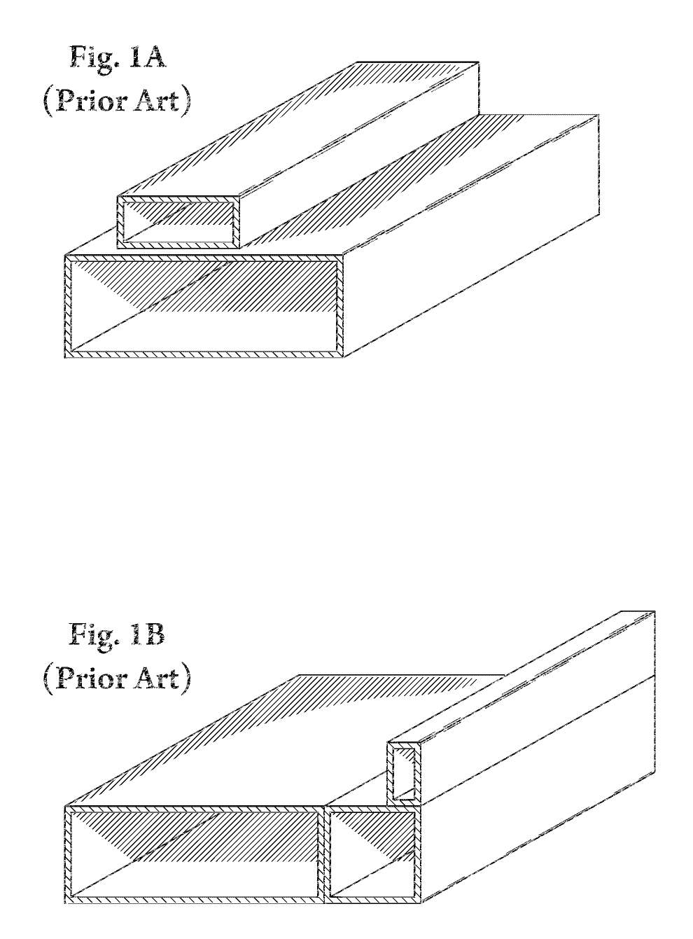

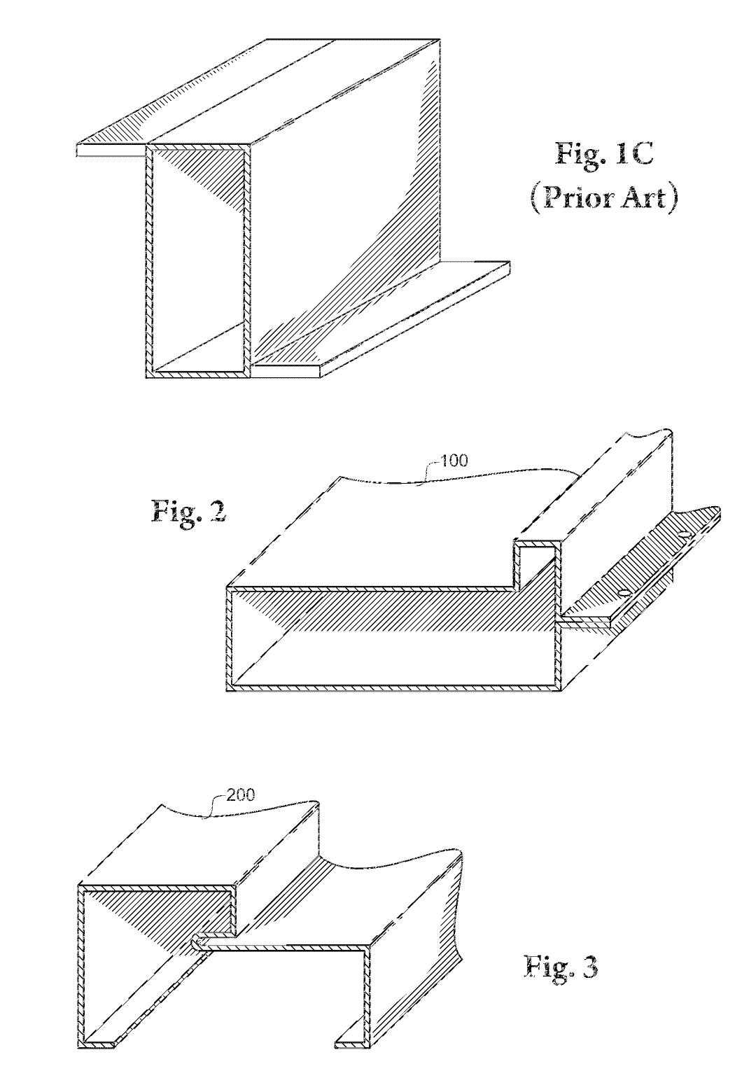

FIGS. 2 and 7 show the preferred embodiment of the steel door stile 110 and steel door rail 120 that are made using 14 gauge sheet metal. The steel door stiles 110 and steel door rails 120 are constructed in the same manner. The only difference is their lengths. This configuration is in contrast to the prior art steel door stile and rail shown in FIG. 1A wherein three pieces of metal are coupled together to create the door stile and door rail. The sheet metal is shaped into the steel door stile 110 and steel door rail 120 by a brake press machine fitted with interchangeable specialized dies that appropriately bend the metal. In the preferred embodiment, the sheet metal for the door stile 110 is cut 10⅜″ wide and either 8′ or 10′ long and the sheet metal for the door rail 120 is cut 3′ long to correspond to the current industry standard.

Once the sheet metal is cut, holes are punched in the door stile 110 metal along its 8′ or 10′ long side and in the door rail 120 along its 3′ long side. More specifically, the holes are 5/16″ in diameter and are spaced 5″ apart. Next, the sheet metal is placed into the brake press machine that is fitted with the special dies. The dies detachably couple to the brake press machine and are shaped such that when the sheet metal is placed in the brake press machine, the dies bend the metal to the desired shape. There are several interchangeable dies that are used throughout the process to shape the metal in different ways.

The first type of die that is used simultaneously bends the metal into two 90° angles. The 90° angles are 3⅛″ from the edge of the metal that includes the punched holes. The second die bends a single 90° angle into the metal. The first 90° angle bend in the metal created by this die is 1⅛″ from the edge of the metal that includes the punched holes. In the next step, the same die is used to create a 90° bend such that this 90° angle is 1 5/16″ from the previously described 90° angle.

Once this series of angles are formed, the opposite edge of the metal is placed in the brake press machine. A 90° angle is bent into this side of the metal ¾″ from the edge of the metal without the holes. Another 90° angle is then formed 1¾″ from the previous 90° angle such that a double “L” shape is formed.

Once the above angles are formed in the sheet metal, another specialized die is coupled to the brake press machine. This die bends a 50° angle into the sheet metal a distance of 6¼″ from the previously described angle. After the 50° angle is bent into the sheet metal, the sheet metal is removed from the brake press machine and turned to the reverse side such that two 90° angles are bent into the metal on opposite sides of the 50° angle. These 90° angles are each respectively ⅞″ from the center of the 50° angle. Next, another type of die is fitted to the brake press machine. This die is used to bend the 50° angle back to a 0° angle such that the sheet metal is formed into the final shape of the steel door stile 110 and door tail 120 shown in FIGS. 2 and 7. Finally, the two edges of the sheet metal are welded together and ground smooth so that the steel door stile 110 and door rail 120 is secured as one piece of metal. The ends of each door stile 110 and door rail 120 are cut such that they are 45° angles.

Once two door stiles 110 and two door tails 120 are completed, they are coupled together at their 45° angle ends as seen in FIG. 10. More specifically, the two steel door stiles 110 are arranged vertically, and the two steel door rails 120 are arranged horizontally. This configuration creates the steel door 100 as part of the steel door system 500 illustrated in FIG. 8.

In the preferred embodiment of the invention, the steel door jamb 200 is made up of three pieces. The first piece 210 and the second piece 220 are the same length and are situated vertically, and the third piece 230 that is shorter and is situated horizontally. This is in contrast to the prior art door jamb component shown in FIG. 1B that is made of two pieces of rectangular metal coupled together.

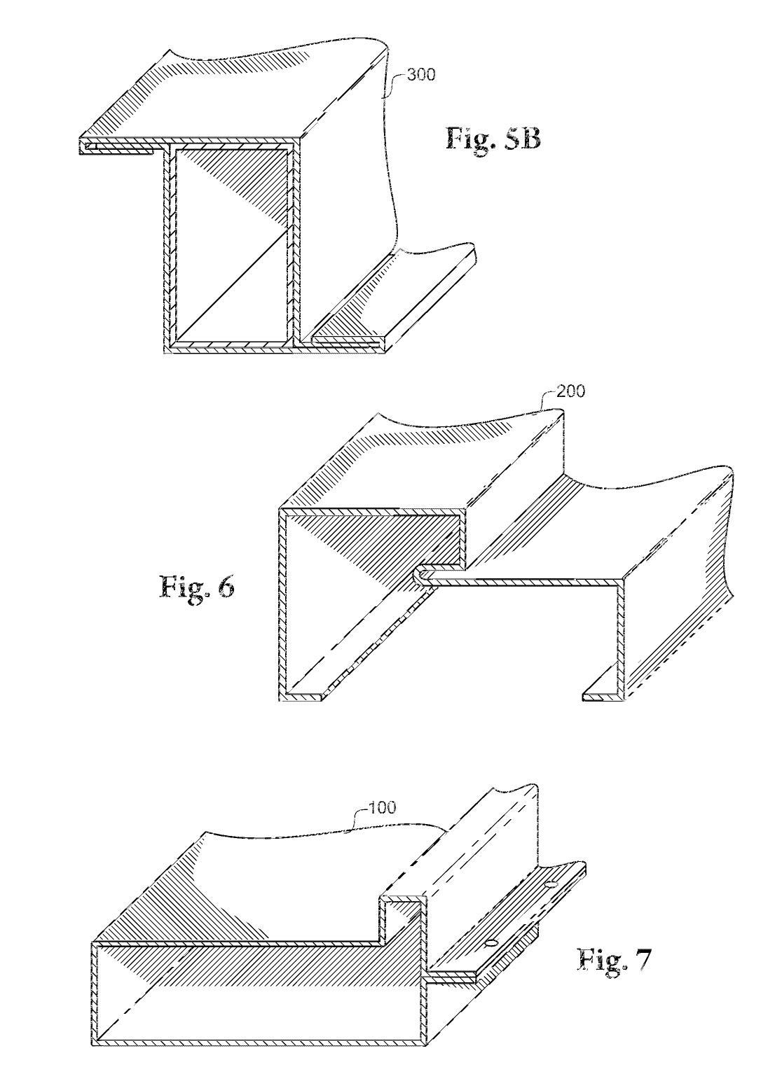

The process of configuring a piece of sheet metal into a single rectangular piece is repeated to create all three steel door jamb pieces 210, 220, and 230, as seen in FIGS. 3 and 6, that make up the steel door jamb 200. Once all three pieces 210, 220, and 230 are formed, a door jamb 200 is configured. This involves placing the three steel pieces 210, 220, and 230 together such that a three-sided rectangle is formed. Both ends of the shorter horizontal steel door jamb piece 230 are cut at 45° angles, while only one end of each of the longer vertical steel door jamb pieces 210 and 220 includes a 45° angle. Each 45° angle end of the shorter horizontal steel door jamb piece 230 is then welded to a 45° angle end of each respective vertical steel door jamb piece 210 and 220. This configuration creates a steel door jamb 200 that is made of three pieces of sheet metal with two welds.

The steel door jamb 200 is shown in FIGS. 3, 6, and 10. The preferred embodiment of the steel door jamb pieces 210, 220, and 230 is created using 14 gauge sheet metal. As with the components of the steel door 100, the components of the steel door jamb 200 are shaped by a press brake machine fitted with specialized dies.

In the preferred embodiment of the invention, a single piece of sheet metal is formed into rectangular shapes that form the steel door jamb components 210, 220, and 230. The dimensions of the steel door jamb 200 are such that the steel door 100 fits securely with the steel door jamb 200 when the steel door 100 is in a closed position.

The two vertical steel door jamb pieces 210 and 220 are constructed of 14 gauge sheet metal that is 10⅜″ wide and either 8′ 3¼″ or 10′ 3¼″ long depending on the length of the steel door 100. The horizontal steel door jamb piece 230 is 14 gauge sheet metal that is 10⅜″ wide and 39½″ long. All three pieces 210, 220, and 230 are constructed the same way in the brake press machine. The only difference is the length of the sheet metal.

The sheet metal is then placed into the brake press machine fitted with a die. The die bends the sheet metal such that a space is made to insert weather stripping into the door jamb 200. The bend is 4 5/16″ from the edge of the piece of metal. A piece of 14 gauge provisional material is insetted into the weather stripping space so that it remains open, and then an angle is bent into the sheet metal such that the two edges of the piece of sheet metal are 90° apart. Next, a 90° angle is bent ¾″ from the center of the previously described 90° angle followed by another 90° bend in the sheet metal that is 3¾″ from the center of the sheet metal. A further 90° bend is then put into the sheet metal 1½″ from the previously described 90° angle.

Once this bend is completed, the sheet metal is removed from the brake press machine, and the opposite edge of the metal is placed in the machine. The die on the machine then places a 90° bend into the sheet metal 4 15/32″ from the center of the piece of sheet metal. In the final step of creating the steel door jamb pieces 210, 220, and 230, the die bends a 90° angle into the sheet metal 2⅛″ from the center of the piece of sheet metal. Once the three pieces 210, 220, and 230 that are each manufactured from a single piece of steel are created, they are configured as described above such that the steel door jamb 200 is created. As discussed above, the reduction in the amount of joints and materials creates a stronger door jamb 200.

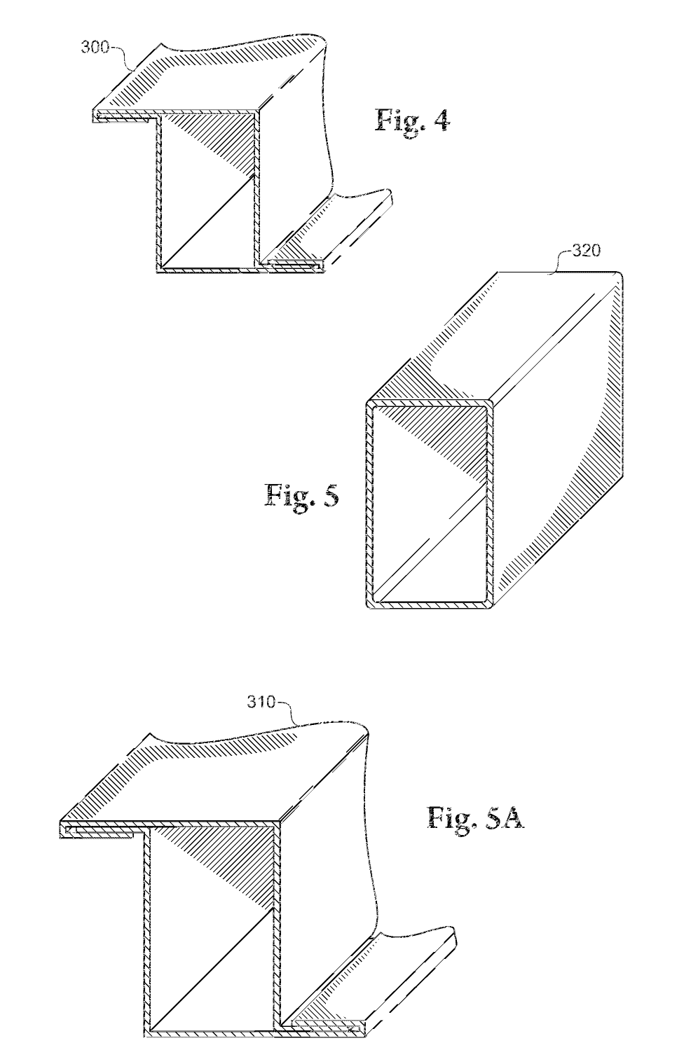

The steel window frame 300 of the current invention is shown in FIGS. 4 and 5-5B. The preferred embodiment of the steel window frame 300 is created using 18 and 20 gauge sheet metal. As with the steel door 100 and the steel door jamb 200, the steel window frame 300 is shaped by a press brake machine fitted with specialized dies. The steel window frame 300 includes two components 310 and 320. The first component 310 is the bent 20 gauge sheet metal, and the second component 320 is an 18 gauge rectangular tubing. The steel window frame 300 is not required for the function of the steel door system 500, but is an alternative embodiment.

To create the first component 310, the 20 gauge sheet metal is shaped by the brake press machine fitted with the interchangeable dies. First, the 20 gauge sheet metal used to create the vertical components 340 is cut at 3½″ wide and either 8′ or 10′ long depending on the length of the steel door 100, and the sheet metal used to create the horizontal components 350 is cut 3½″ wide and 25¾″ long. This cut sheet metal is then bent ½″ from one of the edges at least 45°. The opposite edge of the sheet metal is then put into the brake press machine and bent 90° ½″ from the edge. The sheet metal is then removed from the brake press machine and rotated 180° counterclockwise. The sheet metal is then reinserted into the brake press machine and a 90° angle is bent into the metal 1⅜″ from the original 45° angle. Another piece of sheet metal is then placed into the brake press machine and configured in the exact same way.

Once the two pieces 312 and 314 are properly machined, they are assembled such that one piece rests on top of the other. More specifically, the edge of the first piece of sheet metal 312 that includes the 90° angle is on top of the 45° edge of the second piece of sheet metal 314, and the edge of the first piece of sheet metal 312 that includes the 45° angle is on top of the 90° edge of the second piece of sheet metal 314. The 18 gauge rectangular tubing is then placed inside of the outer rectangular frame created by the two pieces 312 and 314 of bent sheet metal. When the rectangular tubing 320 is in place, the 45° angle ends of the steel window frame structure are placed in the brake press machine and bent such that they curve around the 90° edge of the opposite piece of metal. Finally, the curved edges are spot welded to the underlying metal to ensure that the pieces are appropriately secured together. Once four components are made, they are arranged in a rectangular pattern, and the ends are welded together. The finalized steel window frame 300 is then incorporated into the steel door 100 as seen in FIG. 10.

The window frame 300 is coupled to the hinge side 510 of the steel door 100 by welding barrel hinges 360 on the window frame 300 and to the steel door 100. The window frame 300 is coupled to the latch side 520 of the door by screwing a level latch lock component 370 to the steel door stile 100 and steel window frame 300 to hold the window frame 300 in the closed position. The window frame 300 can be unlatched and opened using the barrel hinges 360 to provide ease of cleaning or ventilation.

The preferred embodiment of the invention is described in the Description of Preferred Embodiments. While these descriptions directly describe the one embodiment, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A steel door system wherein said steel door system comprises:
a. a steel door jamb wherein said steel door jamb further comprises:
i. a top piece wherein said top piece further comprises:
1. a first side; and
2. a second side; and
ii. a pair of side pieces wherein said each side piece further comprises
1. a first edge; and
2. a second edge;
b. a steel door wherein said steel door further comprises:
i. a pair of steel door stiles wherein said pair of steel door stiles each have a first side and a second side; and
ii. a pair of steel door tails wherein said pair of steel door rails each have a first edge and a second edge;
c. said steel door jamb, wherein said top piece and said pair of side pieces of said door jamb each comprise a single sheet of steel;
d. said steel door wherein said pair of steel door stiles and pair of steel door tails each comprise a single sheet of steel;
e. said steel door jamb, wherein said first side of said top piece of said steel door jamb is coupled to said first edge of one of said side pieces of said steel door jamb and said second side of said top piece of said door jamb is coupled to said first edge of second said side piece of said steel door jamb such that said door jamb is created;
f. said steel door, wherein said first side of one of said steel door stiles is coupled to said first edge of one of steel door rails and said second side of said steel door stile is coupled to said first edge of said second steel door rail and wherein said first side of said second steel door stile is coupled to said second edge of said first steel door rail and said second side of said second steel door stile is coupled to said second edge of said second steel door tail; and
g. wherein one of said steel door stiles of said steel door is totally coupled on an axis to one of said side pieces of said steel door jamb.

2. The steel door system of claim 1 further comprising a steel window frame wherein said steel window frame further comprises:
a. a top piece wherein said top piece further comprises:
i. a first side; and
ii. a second side;
b. a bottom piece wherein said bottom piece further comprises:
i. a first side; and
ii. a second side; and
c. a pair of side pieces wherein said each side piece further comprises:
i. a first edge; and
ii. a second edge;
d. wherein said first side of said top piece of said steel window frame is coupled to said first edge of one of said side pieces and said second side of said top piece of said window frame is coupled to said first edge of second said side piece and wherein said first side of said bottom piece of said window frame is coupled to said second edge of one of said side pieces and said second side of said bottom piece of said window frame is coupled to said second edge of second said side piece such that said window frame is created; and
e. wherein said window frame is coupled to said steel door such that said steel door system includes a window.

3. The steel door system of claim 1 wherein said pieces of said steel door jamb and said steel door are welded together.

4. The steel door system of claim 1 wherein said steel door is rotatably coupled to said steel door jamb using a hinge.

5. The steel door system of claim 2 wherein said steel door stiles, said steel door tails, said steel door jamb, and said steel window frame are formed using a brake press machine.

6. The steel door system of claim 5 wherein said brake press is fitted with a die such that said die forms said steel into said steel door stiles and said steel door rails.

7. The steel door system of claim 5 wherein said brake press is fitted with a die such that said die forms said steel into said steel door jamb.

8. The steel door system of claim 5 wherein said brake press is fitted with a die such that said die forms said steel into said steel window frame.

9. A steel door system wherein said steel door system comprises:
a. a steel door jamb wherein said steel door jamb further comprises:
i. a top piece wherein said top piece further comprises:
1. a first side; and
2. a second side; and
ii. a pair of side pieces wherein said each side piece further comprises
1. a first edge; and
2. a second edge;
b. a steel door wherein said steel door further comprises:
1. a pair of steel door stiles wherein said pair of steel door stiles each have a first side and a second side; and
ii. a pair of steel door rails wherein said pair of steel door rails each have a first edge and a second edge;
c. a steel window frame wherein said steel window frame further comprises:
i. a top piece wherein said top piece further comprises:
1. a first side; and
2. a second side;
ii. a bottom piece wherein said bottom piece further comprises:
1. a first side; and
2. a second side; and
iii. a pair of side pieces wherein said each side piece further comprises:
1. a first edge; and
2. a second edge;
d. said steel door jamb, wherein said top piece and said pair of side pieces of said door jamb each comprise a single sheet of steel;
e. said steel door wherein said pair of steel door stiles and pair of steel door tails each comprise a single sheet of steel;
f. said steel door jamb, wherein said first side of said top piece of said steel door jamb is coupled to said first edge of one of said side pieces of said steel door jamb and said second side of said top piece of said door jamb is coupled to said first edge of second said side piece of said steel door jamb such that said door jamb is created;
g. said steel door, wherein said first side of one of said steel door stiles is coupled to said first edge of one of steel door rails and said second side of said steel door stile is coupled to said first edge of said second steel door rail and wherein said first side of said second steel door stile is coupled to said second edge of said first steel door rail and said second side of said second steel door stile is coupled to said second edge of said second steel door rail;
h. wherein said first side of said top piece of said steel window frame is coupled to said first edge of one of said side pieces and said second side of said top piece of said steel window frame is coupled to said first edge of second said side piece and wherein said first side of said bottom piece of said steel window frame is coupled to said second edge of one of said side pieces and said second side of said bottom piece of said steel window frame is coupled to said second edge of second said side piece such that said steel window frame is created;
i. said steel window frame, wherein said steel window frame is coupled to said steel door such that said steel door system includes a window; and
j. wherein one of said steel door stiles of said steel door is totally coupled on an axis to one of said side pieces of said steel door jamb.

10. The steel door system of claim 9 wherein said pieces of said steel door jamb and said steel door are welded together.

11. The steel door system of claim 9 wherein said steel door is rotatably coupled to said steel door jamb using a hinge.

12. The steel door system of claim 9 wherein said steel door stiles, said steel door rails, said steel door jamb, and said steel window frame are formed using a brake press machine.

13. The steel door system of claim 12 wherein said brake press is fitted with a die such that said die forms said steel into said steel door stiles and said steel door tails.

14. The steel door system of claim 12 wherein said brake press is fitted with a die such that said die forms said steel into said steel door jamb.

15. The steel door system of claim 12 wherein said brake press is fitted with a die such that said die forms said steel into said steel window frame.
